(19) United States
(12) Patent Application Publication
(10) Pub. No.: US 2010/0257073 A1
(43) Pub. Date: Oct. 7, 2010

(54) Duplicate Payment Prevention

(76) Inventors: Frank Stokes, Boone, NC (US); Steven Fortson, Little River, SC (US); Charles Brinza, Granite City, IL (US); Richard Gierak, Clayton, CA (US); Noreen Sila, Underhill, VT (US); Ronald Larry Ratzlaff, Colorado Springs, CO (US)

Correspondence Address: STRASBURGER & PRICE, LLP;ATTN: IP SECTION, 1401 MCKINNEY, SUITE 2200, HOUSTON, TX, 77010, US

(21) Appl. No.: 12/608,767

(22) Filed: Oct. 29, 2009

Related U.S. Application Data
(60) Provisional application No. 61/197,800, filed on Oct. 30, 2008.
(60) Provisional application No. 61/197,794, filed on Oct. 30, 2008.
(60) Provisional application No. 61/197,756, filed on Oct. 30, 2008.

(51) Int. Cl. G06Q 10/00; G06F 17/30

(52) U.S. Cl. 705/30; 707/802; 707/769; 707/E17.005; 707/E17.014

(57) ABSTRACT

A computer implemented method and system may identify duplicate payment transactions.

### CROSS-REFERENCE TO RELATED APPLICATIONS

This application claims the benefit of U.S. Provisional Application Nos. 61/197,800, 61/197,794 and 61,197,756 filed on Oct. 30, 2008, which applications are hereby incorporated by reference for all purposes in their entirety.

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. Field of the Invention

The present invention relates to payment transactions and more particularly to banking programs.

2. Description of the Related Art

With the advent of the Check 21 legislation, payments originating as checks are now entering financial institutions' payments streams in various forms, including automated clearinghouse (ACH) payments, electronic cash letters, X9.37 electronic files from customers and other capture centers, paper checks and Image Replacement Documents. For example, a paper check may be scanned at a retail check-out counter and converted to an ACH transaction. Another example occurs when banks exchange electronic cash letters consisting of the checks' electronic images instead of exchanging the actual checks. Still another example occurs when paper checks are captured in a remote processing center and then converted into X9.37 format and transmitted to a consolidating location.

Conversion of paper checks to various electronic media has created opportunities for Banks to save on processing costs, float, and transportation. However, this flexibility of payment presentment has created an environment where the same payment can be presented multiple times and posted to the individual customer account multiple times. This “double posting” of payments, although unintentional, causes customer relationship problems and results in added expense to the bank. Correcting these errors costs the bank both time and money, as well as risking customer satisfaction and the bank's reputation.

### BRIEF SUMMARY OF THE INVENTION

A computer implemented method and system are provided for comparing payment transactions and identifying duplicate transactions. In one embodiment, prior payment transactions that have been received may be loaded into a duplicate detection data base. Later selected payment transactions that are received may also be loaded into the duplicate detection data base and a high-performance data comparison technology may be used to compare the later payments in the data base as they arrive with the payments previously loaded into the data base for duplicate payment transactions. Any match in the comparison may be designated as a duplicate suspect and may be reviewed to determine if the suspect is a valid duplicate payment. Duplicates may be forwarded to a posting system to prevent payment and to prevent the duplicate payment from posting to the customer's account.

Exceptions, including returned items, stop payments, and insufficient funds, may be given special consideration to prevent them from being identified as duplicate payments. The duplicate payment prevention system may distinguish these items from true duplicate payments.

### BRIEF DESCRIPTION OF THE DRAWINGS

For a better understanding of the nature and object of the present invention reference should be had to the following drawings in which like parts are given like reference numerals and wherein:

FIG. 1 is a schematic block diagram of the method for preventing duplicate payments.

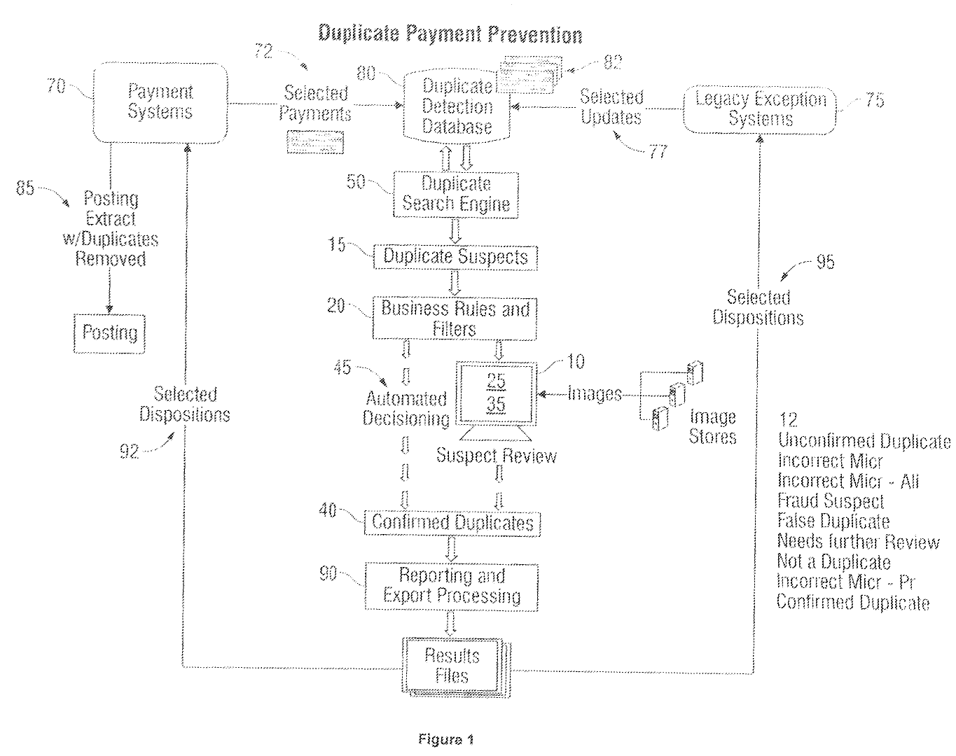

### DETAILED DESCRIPTION OF THE INVENTION

The method and system may prevent duplicate postings by comparing selected payments 72, regardless of source of entry into the bank, with every other payment 82 received by the bank during a prior period of time, such as the last 30+ days. This is done by loading selected payments 72 arriving at the bank into a duplicate detection or relational data base 80 and using a high-performance data comparison technology 50 to compare payments 72 as they arrive at the bank with the payments 82 loaded into the data base 80. As each new payment is compared 50 to previously entered payments to determine possible duplicates (duplicate suspects), a file 15 may be created containing all positive matches to the compare activity 50. This file 15 may then be presented preferably by a workstation 10 to the operations personnel (not shown) for resolution. A Duplicate Payments Suspect Review Workstation 10 is proposed in U.S. Provisional Application No. 61/197,800 filed on Oct. 30, 2008 and incorporated herein by reference for all purposes in its entirety. Other methods and systems for resolution are contemplated. A Process for Resolving Duplicate Payment Postings in Day 1 is proposed in U.S. Provisional Application No. 61/197,794 filed on Oct. 30, 2008 and incorporated herein by reference for all purposes in its entirety.

Returned items that have been denied payment from correspondent banks may make up a significant portion of items that may be identified as false positive duplicates because returns may enter the duplicate data base more than once. A payment may be presented by a bank to a correspondent bank for payment multiple times. Each time the payment is presented, it may appear as a duplicate payment. The duplicate payment prevention system distinguishes these items from true duplicate payments.

The duplicate detection data base 80 is used by the duplicate search engine 50 to compile the duplicate suspects 15. Selected payments 72 are ingested into the data base 80 from the payment system 70. Selected updates 77 originating from the bank's legacy exception systems 75 can also be ingested into the data base 80. For example, updates from the bank's Returns system can be ingested into the data base 80 to identify any returned items so that those items will not be falsely identified as duplicates upon re-presentment. Updates from the bank's Adjustment system can be ingested so that existing items in the data base 80 will reflect any changes to MICR and other data made during the Adjustment process.

The present invention includes a reporting capability 90 such that all items processed through the payment system interface are updated 92 with, a disposition code assigned either automatically via the business rules or manually by an operator. Downstream payment processes (e.g., balancing, posting, and transit processing) use this information to resolve the exception conditions identified in the appropriate manner. (For example, removal of the confirmed duplicates from posting extracts 85 or cash letter processing.)

The present invention also includes an export capability 90 that supports reporting of selected items to any external bank system based on the assigned disposition codes. For example, any changes in duplicate status 95 resulting from the processing of updates 77 from the bank's legacy exception systems 75 can be reported back to the system from which the updates were presented. Another example is the reporting of items dispositioned as “fraud suspects” to the bank's fraud systems for resolution.

It should be understood that although the method and system are described with regard to banks, the method and system are equally applicable to other businesses having payment transactions.

The foregoing disclosure and description of the invention are illustrative and explanatory thereof, and various changes in the details of the illustrated apparatus and system, and the construction and method of operation may be made without departing from the spirit of the invention.

We claim:

1. A computer implemented method comprising the steps of:
providing a computer software program for identifying duplicate payment transactions;
submitting first payment transactions to said computer software program at a first time;
providing a data base to said computer software program comprising second payment transactions for a time period ending at or before said first time;
comparing said first payment transactions with said second payment transactions; and
identifying if said first payment transactions are contained in said data base.

2. The method of claim 1, further comprising the step of:
reporting whether said first payment transactions are contained in said data base.

3. The method of claim 2, wherein said reporting occurring on a workstation display.

4. The method of claim 1, further comprising the step of:
posting any of said first payment transactions that are not contained in said data base.

5. The method of claim 1, wherein said data base is a duplicate data base.

6. The method of claim 1, wherein said data base is continuously updated.

7. The method of claim 1, further comprising the step of:
providing third payment transactions to said computer software program;
updating said data base;
comparing said third payment transactions with said updated data base; and
identifying if said third payment transactions are contained in said updated data base.

8. The method of claim 7, further comprising the step of:
reporting whether said third payment transactions are contained in said updated data base.

9. The method of claim 8, wherein said reporting occurring on a workstation display.

10. The method of claim 7, further comprising the step of:
posting any of said third payment transaction that are not contained in said updated data base.

11. The method of claim 7, wherein updating said data base comprising updating with said first payment transactions.

12. The method of claim 11, further comprising the step of:
reporting whether said third payment transactions are contained in said updated data base.

13. The method of claim 11, further comprising the step of:
posting any of said third payment transactions that are not contained in said updated data base.
